(19) United States
(12) Patent Application Publication
(10) Pub. No.: US 2007/0045073 A1
(43) Pub. Date: Mar. 1, 2007

(54) Reel apparatus

(76) Inventors: Chengxin Cao, Beijing (CN); Nan Jiang, Beijing (CN); Weifeng Yu, Beijing (CN)

Correspondence Address: Merek, Blackmon & Voorhees, LLC, 673 S. Washington St., Alexandria, VA, 22314, US

(21) Appl. No.: 11/508,875

(22) Filed: Aug. 24, 2006

(30) Foreign Application Priority Data
Aug. 25, 2005 (CN) 200510086281.8

(51) Int. Cl. H02G 11/02

(52) U.S. Cl. 191/12.2 R

(57) ABSTRACT

A reel apparatus for a moveable system comprises a base disposed on the moveable system; a rotatable drum rotatably supported on the base onto which a cable can be spooled; a speed reducer for rotating the drum; a motor drive the speed reducer; a first transmission device coupled between the motor and the speed reducer; a coupling coupled between the speed reducer and the motor, when a load of the drum exceeds a predetermined torque, the coupling slips so as to limit a drive torque transmitted from the motor to the speed reducer to stop the drum; and an electrical connector connected at one end to a power cord of the moveable system and slidably contacted with the other end thereof with one end of the cable. With the present invention, a commercial power supply can be connected to the moveable system directly, thus reducing components of the conventional power supplying apparatus. At the same time, the cable sheath is prevented from being damaging and potential safety hazards are eliminated.

### BACKGROUND OF THE INVENTION

1. Technical Field of the Invention

The present invention relates to a reel apparatus, and particularly to a reel apparatus for spooling and unspooling a linear material such as a cable used to supply commercial power to a moveable system.

2. Description of the Related Art

When a moveable system such as a movable scanning system for inspecting a vehicle carrying containers operates, it is required to supply power from an external power supply. Generally, the moveable system is supplied with power from an electrical generator. However, in some situations, supplying power using the electrical generator is restrained by many conditions, so that a commercial power supply has to be used.

The conventional commercial power supplying apparatus mainly comprises a current collector, a sliding contact means, and a cable dragging means which cooperate to enable the commercial power supply to a moveable system.

However, the conventional commercial power supplying apparatus is restrained by many conditions on site, so that troubles and failure occur in supplying power to the moveable system. Particularly, the cable dragging means tends to damage the sheath of the cable, thus causing potential safety hazards.

### SUMMARY OF THE INVENTION

One aspect of the present invention is to solve at least part of the above problems existing in the prior art.

One embodiment of the present invention provides a reel apparatus for spooling or unspooling a cable used to supply power to a moveable system. The reel apparatus according to the present invention connects a commercial power supply to the moveable system directly, thus reducing components of the conventional commercial power supplying apparatus. At the same time, the cable sheath is prevented from being damaged and potential safety hazards are eliminated.

The reel apparatus for a moveable system according to the embodiments of the present invention comprises a base adapted to be mounted on the moveable system;

a rotatable drum rotatably supported on the base, a cable can be spooled onto or unspooled from the rotatable drum;

a speed reducer, an output side of which is coupled to the rotatable drum to rotate the rotatable drum;

a motor coupled to an input side of the speed reducer for rotating the speed reducer in a direction of spooling the cable;

a first transmission device coupled between the motor and the speed reducer for transmitting a dive torque of the motor to the speed reducer;

a coupling coupled between the input side of the speed reducer and the motor; when a load of the rotatable drum exceeds a predetermined torque during spooling of the cable, the coupling slips so as to limit a drive torque transmitted from the motor to the speed reducer and thereby to the rotatable drum to be smaller than the predetermined torque, thus preventing the cable from being broken due to pulling of the rotatable drum; and

an electrical connector, which has a first end being connected to a power cord of the moveable system and has a second end being slidably contacted with one end of the cable, while the other end of the cable is connected to an external power supply.

Preferably, the coupling comprises a magnetic hysteresis coupling.

The reel apparatus according to the embodiment of the present invention further comprises a cable arranging device adapted to control the cable to be spooled onto or unspooled from the rotatable drum regularly and orderly; and a second transmission device coupled between the rotatable drum and the cable arranging device for transmitting a rotation force of the rotatable drum to the cable arranging device, thereby the cable arranging device is driven to translate to control spooling and unspooling of the cable.

Preferably, the cable arranging device comprises a screw rod disposed to be parallel with a rotation axis of the rotatable drum and driven to rotate by the second transmission device; a nut member capable of reciprocating along the screw rod to control the cable to be spooled onto or unspooled from the rotatable drum regularly and orderly; and a guide rod disposed parallel with the screw rod and adapted to prevent the nut member from rotating about the screw rod.

The reel apparatus according to the embodiment of the present invention further comprises a cable guide device disposed at a downstream side of the cable arranging device in a direction of unspooling the cable to guide the cable.

In addition, the cable guide device comprises a first rotation roll and a second rotation roll which are disposed parallel with each other and leveled with the screw rod.

Further, the first transmission device comprises a belt drive device.

Preferably, the second transmission device comprises a chain drive device including a first sprocket wheel coupled to an end of the screw rod, a second sprocket wheel coupled to a. rotation shaft of the rotatable drum, and a chain engaged between the first sprocket wheel and the second sprocket wheel.

The reel apparatus according to the embodiment of the present invention further comprises an accessory handwheel disposed at a side of the rotatable drum and used to rotate the rotatable drum manually.

Preferably, the electrical connector comprises an electrical brush disposed inside the rotatable drum.

In addition, the magnetic hysteresis coupling is coupled to an output shaft of the motor.

Alternatively, the magnetic hysteresis coupling is coupled to the rotation shaft of the rotatable drum.

Preferably, the magnetic hysteresis coupling, the speed reducer, and the rotatable drum are coupled to one another coaxially.

The reel apparatus according to the embodiment of the present invention further comprises a first bracket and a second bracket which support rotatably both ends of the rotation shaft of the rotatable drum.

In addition, the external power supply comprises a commercial power supply.

With the reel apparatus according to the embodiments of the present invention, the electrical brush disposed inside the rotatable drum can contact the commercial power supply slidably, so that the commercial power can be supplied directly to the movable system through the cable.

With the reel apparatus according to the embodiments of the present invention, it is not necessary to use the current collector, the sliding contact means, and the cable dragging means, so that the restraints are overcome, thus increasing efficiency.

Further, the reel apparatus according to the embodiments of the present invention employs a magnetic hysteresis coupling, so that the torque of the motor is converted into a constant torque by the magnetic hysteresis coupling, and then the constant torque is transmitted to the rotatable drum of the reel apparatus, so that the cable is kept to be stationary relative to the ground after passing the cable arranging device and the cable guide device. In addition, when the load (torque) of the rotatable drum exceeds the predetermined torque (the maximum torque that can be transmitted from the motor to the speed reducer/the rotatable drum), the magnetic hysteresis coupling will skip (idle), so that the motor cannot drive the rotatable drum to rotate any more. Therefore, the cable sheath is prevented from being damaged during spooling and unspooling, thus ensuring the safety of work on site.

### BRIEF DESCRIPTION OF THE DRAWINGS

The above and/or additional aspects and advantages of the present invention will become apparent by the following descriptions of the embodiments in conjunction with the accompanying drawings, in which:

FIG. 1 is a structural schematic view showing a reel apparatus according to an embodiment of the present invention;

FIG. 2 is a schematic right view of the reel apparatus in FIG. 1.

### DETAILED DESCRIPTION OF THE PREFERRED EMBODIMENTS OF THE INVENTION

Embodiments of the present invention will be described in detail with reference to the accompany drawings, the embodiments described herein are explanatory and illustrative and shall not be construed to limit the present invention.

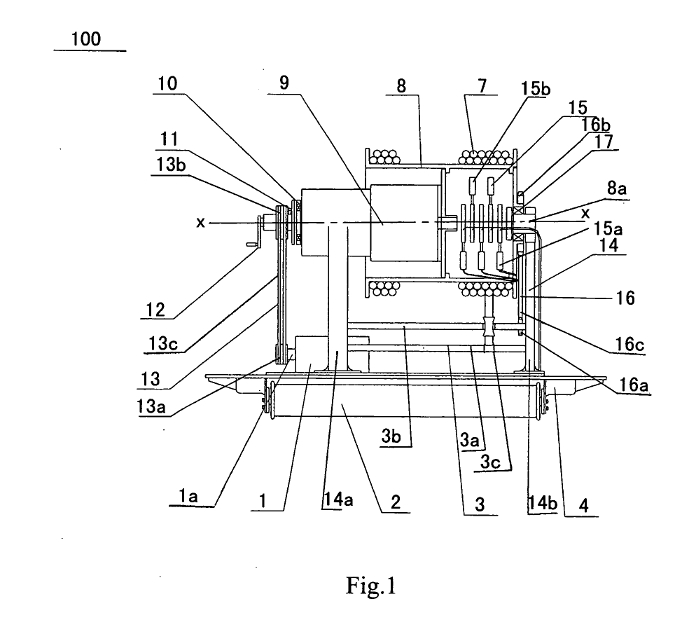

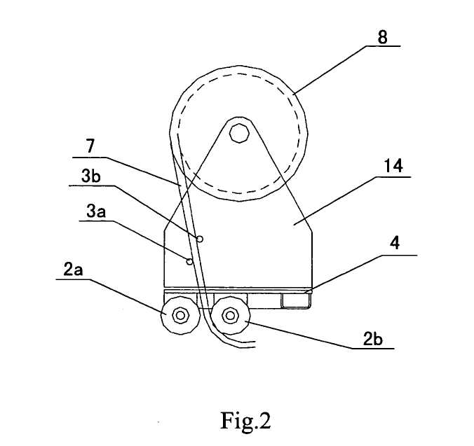

As shown in FIGS. 1 and 2, a reel apparatus 100 according to the embodiment of the present application comprises a base 4 and a rotatable drum 8 rotatably supported on the base 4, so that a linear material such as a cable 7 can be spooled onto or unspooled from the rotatable drum 8.

Preferably, the drum 8 is provided with rotation shafts 8a on both sides thereof (in FIG. 1, only a rotation shaft 8a on the right side is shown). A first bracket 14a and a second bracket 14b are disposed on the base 4 so as to support rotatably the rotation shafts 8a on both sides of the drum 8 respectively. For example, the first and second brackets 14a and 14b support the rotation shafts 8a through bearings 17 so as to reduce a resistance force to the rotation of the drum 8. One skilled in the art can understand that the bearings 17 can be replaced by a friction sleeves. Of course, the shafts 8a can be fitted directly in the first and second brackets 14a and 14b without using the bearings 17 or friction sleeves.

The reel apparatus further comprises a speed reducer 9 and a motor 1 to drive the speed reducer 9. The motor 1 is mounted on the base 4. An input side of the speed reducer 9 is coupled to a rotation shaft 1a of the motor 1 and an output side of the speed reducer 9 is coupled to the drum 8. For example, an output shaft (not shown) of the speed reducer 9 is coupled to the rotation shafts 8a on one side (left side in FIG. 1) of the drum 8. It should be noticed that the motor 1 is energized only when spooling the cable 7 onto the drum 8. When unspooling the cable 7 from the drum 8, the motor 1 is not energized, and the cable 7 is unspooled from the drum 8 by using the pulling force of the movable system.

A first transmission device 13 is coupled between the motor 1 and the speed reducer 9 so as to transmit a dive torque (rotation force) of the motor 1 to the speed reducer 9. Preferably, the first transmission device 13 comprises a belt drive device, and the belt drive device includes a first belt pulley 13a mounted on the rotation shaft 1a of the motor 1, a second belt pulley 13b mounted on the input shaft (not shown) of the speed reducer 9, and a belt 13c engaged between the first and second belt pulleys 13a and 13b. However, the first transmission device 13 is not limited to the belt drive device and can be suitable transmission device in the art.

A coupling 10 is coupled between the input side of the speed reducer 9 and the motor 1 (the rotation shaft 1a). During spooling of the cable 7, if the load of the drum 8 exceeds a predetermined torque (the maximum torque that can be transmitted from the motor 1 to the speed reducer 9/dum 8) during spooling of the cable 7, the coupling 10 slips (idles) so that the drive torque transmitted from the motor 1 to the speed reducer 9 and thereby to the drum 8 is limited. For example, when the cable 7 is caught by an object and cannot be spooled on to the drum 8, the coupling 10 skips so as to limit the drive torque transmitted from the motor 1 to the speed reducer 9 (drum 8), thereby the drum 8 stops rotating to prevent the cable 7 from being broken due to pulling of the drum 8.

In other words, when the load of the drum 8 exceeds the predetermined torque (maximum torque), the coupling 10 skips, so that the torque transmission from the motor 1 to the speed reducer 9/durm 8 is smaller than the load of the drum 8, thereby the drum 8 does not rotate and thereby does not spool the cable 7, thus preventing the cable 7 from being broken due to pulling of the drum 8. The maximum torque (predetermined torque) that can be transmitted from the motor 1 to the speed reducer 9 (drum 8) is determined by the coupling 10 and can be changed by adjusting the coupling 10.

Particularly, the coupling 10 may be mounted on the rotation shaft 1a of the motor 1 and the first belt pulley 13a is mounted on an output side of the coupling 10. Alternatively, the coupling 10 may be mounted on the input shaft of the speed reducer 9, and the second belt pulley 13b is mounted on an input side of the coupling 10, as shown in FIG. 1.

The coupling 10 is preferably a magnetic hysteresis coupling, but is not limited to this. The coupling 10 can be any one of the suitable couplings in the art as long as it can ensure that the drive toque transmitted from the motor 1 to the speed reducer 9/drum 8 does not exceed the predetermined torque.

An electrical connector 15 is disposed insulatively inside the drum 8. One end 15a of the electrical connector 15 is connected to a power cord of the moveable system and the other end 15b thereof is slidably in contact with one end of the cable 7, while the other end of the cable 7 is connected to an external power supply (not shown), so that the power from the external power supply is provided to the moveable system during moving of the moveable system. The external power supply includes a commercial power supply and an electric generator but is not limited to these. Preferably, the electrical connector 15 is an electrical brush, but is not limited to this.

The reel apparatus 100 according to the embodiment of the present invention further comprises a cable arranging device 3 and a second transmission device 16 coupled between the drum 8 and the cable arranging device 3. The cable arranging device 3 controls the cable 7 to be spooled onto or unspooled from the drum 8 regularly and orderly and includes a screw rod 3a disposed parallel with a rotation axis X of the drum 8, a nut member 3c screw-engaged with the screw rod 3a and through which the cable 7 passes, and a guide rod 3b disposed to be parallel with the screw rod 3a and adapted to prevent the nut member 3c from rotating about the screw rod 3a.

The second transmission device 16 transmits a rotation force of the drum 8 to the cable arranging device 3 and preferably is a chain drive device. The chain drive device includes a first sprocket wheel 16a coupled to an end of the screw rod 3a, a second sprocket wheel 16b coupled to the rotation shaft 8a of the drum 8 on the right side in FIG. 1, and a chain 16c engaged between the first sprocket wheel 16a and the second sprocket wheel 16b. The second transmission device 16 is not limited to the chain drive device and can be any suitable one in the art.

For example, when the cable 7 is to be spooled onto the drum 8, the drum 8 rotates by means of the drive of the motor and the speed reducer 9, so as to rotate the screw rod 3a through the chain drive device 16, thereby the nut member 3c screw-engaged with the screw rod 3a translates along the screw rod 3a, so that the cable 7 passing through the nut member 3c is spooled onto the drum 8 regularly and orderly. When the nut member 3c reaches an end of the screw rod 3a, the nut member 3c turns and moves towards the other end of the screw rod 3a by means of the characteristic of the screw rod 3a, so that the cable 7 is orderly spooled onto the drum 8 layer by layer by the reciprocating movement of the nut member 3c along the screw rod 3a, during this operation, the guide rod 3b prevents the nut member 3c from rotating about the screw rod 3a. The operation of unspooling the cable 7 from the drum 8 is similar to the above spooling operation, so that the detailed descriptions thereof are omitted.

Moreover, a cable guide device 2 is disposed at a downstream side of the cable arranging device 3 in a direction of unspooling the cable 7 and used to guide spooling and unspooling of the cable 7 so as to avoid damaging the cable sheath of the cable 7. The cable guide device 2 preferably includes a first rotation roll 2a and a second rotation roll 2b which are disposed parallel with each other and leveled with the screw rod 3a, with the cable 7 passing therebetween, as shown in FIG. 2.

Preferably, an accessory handwheel 12 is mounted on the input shaft of the speed reducer 9 at a side of the drum and used to rotate the drum 8 manually. For example, when the power provided to the motor 1 fails or the cable 7 to be spooled is very short, the drum 8 can be rotated manually by using the accessory handwheel 12.

As shown in FIG. 1, the magnetic hysteresis coupling 10, the speed reducer 9, and the drum 8 are coupled to one another sequentially and coaxially along the axis X, and the accessory handwheel 12 is mounted at the input side of the magnetic hysteresis coupling 10.

The operation of the reel apparatus 100 according to the embodiment of the present invention is described with reference to FIGS. 1 and 2 below.

In use, the reel apparatus 100 is mounted on the moveable system via the base 4, the electrical brush 15. is connected to the power cord of the moveable system at one end 15a and slidably contacted with one end of the cable 7 at the other end 15b thereof, while the other end of the cable 7 is connected to the commercial power supply, thereby the commercial electric power is supplied to the moveable system.

In order to spool the cable 7 onto the drum 8, the motor 1 is energized to rotate, the rotation torque of the motor 1 is transmitted to the magnetic hysteresis coupling 10 through the belt drive device 13, then to drum 8 via the speed reducer 9, so that the drum 8 rotates in a direction of spooling the cable 7 onto the drum 8 so as to spool the cable 7 onto the outer circumference of the drum 8. During rotation of the drum 8, the drum 8 rotates the screw rod 3a via the chain drive device 16, the nut member 3c through which the cable 7 passing moves along the screw rod 3a by the rotation of the screw rod 3a, so that the nut member 3c guides and controls the cable 7 to be spooled orderly onto the outer circumference of the drum 8 layer by layer.

As the drum 8 rotates by one revolution, the nut member 3c moves one stroke along the screw rod 3a in a first direction (for example, leftward direction in FIG. 1). When the drum further rotates by another revolution continuously, the nut member 3c moves one stroke along the screw rod 3a in the first direction accordingly, so that the cable 7 is spooled orderly onto the outer circumference of the drum 8 round by round. When the nut member 3c reaches the end (left end in FIG. 1) of the screw rod 3a, as the drum 8 further rotates, the nut member 3c returns and moves towards the other end of the screw rod 3a along the screw rod 3a in a second direction (rightward direction FIG. 1) opposite to the first direction, so that the cable 7 is spooled onto the cable that has been spooled onto the drum 8. Therefore, by the reciprocating movement of the nut member 3c along the screw rod 3a, the cable 7 is spooled orderly onto the drum 8 layer by layer.

When the load of the drum 8 exceeds the predetermined torque, for example, when the cable 7 is caught by an object, the magnetic hysteresis coupling 10 slips, so that torque transmitted from the motor 1 is smaller than the load of the drum 8, thereby the drum 8 stops rotating, therefore, the cable 7 is prevented from being broken due to the pulling of the drum 8.

The maximum torque that can be transmitted from the motor 1 to the drum 8, i.e. the predetermined torque, can be changed by adjusting the parameters of the magnetic hysteresis coupling 10.

The operation of unspooling the cable 7 from the drum 8 is described below.

When unspooling the cable from the drum 8, the motor 1 is not energized, and the brake (not shown) of the motor 1 is opened, then the cable 7 is unspooled from the drum 8 by means of the pulling force of the moveable system which is moving. When unspooling the cable 7 from the drum 8, the drum 8 rotates by the pulling of the cable 7, so as to rotate the screw rod 3a via the chain drive device 16, thereby the nut member 3c reciprocates along the screw rod 3a, therefore, the cable 7 is unspooled orderly from the drum 8 layer by layer.

During spooling or unspooling of the cable 7, the cable 7 passes between the first rotation roll 2a and the second rotation roll 2b and is guided by the first and second rotation rolls 2a and 2b, as shown in FIG. 2, so that the spooling and unspooling of the cable 7 is more smooth, thus preventing the cable 7 from being damaged.

In addition, if the power supplied to the motor 1 fails during spooling of the cable 7 or the cable 7 to be spooled is very short, the accessory handwheel 12 can be used to rotate the drum 8 manually so as to spool the cable 7 more accurately.

While preferred embodiments of the invention have been described and illustrated above, it should be understood that these are exemplary illustrations of the invention and are not to be considered as limitation. Additions, omissions, substitutions and other modifications can be made without departing from the sprit or scope of the present invention. Accordingly, the invention is not to be considered as being limited by the foregoing description, and is only limited by the scope of the appended claims and the equivalents thereof.

1. A reel apparatus for a moveable system, comprising:
a base adapted to be mounted on the moveable system;
a rotatable drum rotatably supported on the base, a cable can be spooled onto or unspooled from the rotatable drum;
a speed reducer, an output side of which is coupled to the rotatable drum to rotate the rotatable drum;
a motor coupled to an input side of the speed reducer and adapted to rotate the speed reducer in a direction of spooling the cable;
a first transmission device coupled between the motor and the speed reducer and adapted to transmit a dive torque of the motor to the speed reducer;
a coupling coupled between the input side of the speed reducer and the motor, when a load of the rotatable drum exceeds a predetermined torque during spooling of the cable, the coupling slips so as to limit a drive torque transmitted from the motor to the speed reducer and thereby to the rotatable drum to be smaller than the predetermined torque, thus preventing the cable from being broken due to pulling of the rotatable drum; and
an electrical connector, a first end of which is connected to a power cord of the moveable system and a second end thereof is connected is slidably contacted with one end of the cable, and the other end of the cable is connected to an external power supply.

2. The reel apparatus according to the claim 1, wherein the coupling comprises a magnetic hysteresis coupling.

3. The reel apparatus according to the claim 2, further comprising:
a cable arranging device adapted to control the cable to be spooled onto or unspooled from the rotatable drum regularly and orderly; and
a second transmission device coupled between the rotatable drum and the cable arranging device to transmit a rotation force of the rotatable drum to the cable arranging device, thereby the cable arranging device is driven to translate to control spooling and unspooling of the cable.

4. The reel apparatus according to the claim 3, wherein the cable arranging device comprises:
a screw rod disposed to be parallel with a rotation axis of the rotatable drum and driven to rotate by the second transmission device;
a nut member capable of reciprocating along the screw rod to control the cable to be spooled onto or unspooled from the rotatable drum regularly and orderly; and
a guide rod disposed to be parallel with the screw rod and adapted to prevent the nut member from rotating about the screw rod.

5. The reel apparatus according to the claim 4, further comprising:
a cable guide device disposed at a downstream side of the cable arranging device in a direction of unspooling the cable to guide the cable.

6. The reel apparatus according to the claim 5, wherein the cable guide device comprises a first rotation roll and a second rotation roll which are disposed parallel with each other and leveled with the screw rod.

7. The reel apparatus according to the claim 6, wherein the first transmission device comprises a belt drive device.

8. The reel apparatus according to the claim 7, wherein the second transmission device comprises a chain drive device including a first sprocket wheel coupled to an end of the screw rod, a second sprocket wheel coupled to a rotation shaft of the rotatable drum, and a chain engaged between the first sprocket wheel and the second sprocket wheel.

9. The reel apparatus according to the claim 8, further comprising an accessory handwheel disposed at a side of the rotatable drum and used to rotate the rotatable drum manually.

10. The reel apparatus according to the claim 9, wherein the electrical connector comprises an electrical brush disposed inside the rotatable drum.

11. The reel apparatus according to the claim 10, wherein the magnetic hysteresis coupling is coupled to an output shaft of the motor.

12. The reel apparatus according to the claim 10, wherein the magnetic hysteresis coupling is coupled to a rotation shaft of the rotatable drum.

13. The reel apparatus according to the claim 12, wherein the magnetic hysteresis coupling, the speed reducer, and the rotatable drum are coupled to one another coaxially.

14. The reel apparatus according to the claim 1, further comprising a first bracket and a second bracket which support rotatably both ends of the rotation shaft of the rotatable drum.

15. The reel apparatus according to the claim 1, wherein the external power supply comprises a commercial power supply.

16. The reel apparatus according to the claim 2, wherein the coupling comprises a magnetic hysteresis coupling coupled to an output shaft of the motor.

17. The reel apparatus according to the claim 2, wherein the coupling comprises a magnetic hysteresis coupling coupled to a rotation shaft of the rotatable drum.

18. The reel apparatus according to the claim 17, wherein the magnetic hysteresis coupling, the speed reducer, and the rotatable drum are coupled to one another coaxially.
